(19) United States
(12) Patent Application Publication
(10) Pub. No.: US 2010/0055530 A1
(43) Pub. Date: Mar. 4, 2010

(54) POLYMER ELECTROLYTE FUEL CELL

(75) Inventors: Kousuke Kawajiri, Okazaki-shi (JP); Hideto Tanaka, Okazaki-shi (JP); Tomoyuki Takamura, Toyota-shi (JP); Yoshinori Shinozaki, Toyota-shi (JP); Kazutaka Iizuka, Nisshin-shi (JP); Mikio Wada, Toyota-shi (JP); Chisato Kato, Aichi-gun (JP); Nobuo Kanai, Toyota-shi (JP)

Correspondence Address: ROSSI, KIMMS & McDOWELL LLP., 20609 Gordon Park Square, Suite 150, Ashburn, VA, 20147, US

(73) Assignees: TOYOTA SHATAI KABUSHIKI KAISHA, Kariya-shi, Aichi (JP); TOYOTA JIDOSHA KABUSHIKI KAISHA, Toyota-shi, Aichi (JP)

(21) Appl. No.: 12/515,455

(22) PCT Filed: Feb. 28, 2008
(86) PCT No.: PCT/JP2008/054003

§ 371 Date: May 19, 2009

(30) Foreign Application Priority Data
Mar. 7, 2007 (JP) 2007-56808

(51) Int. Cl. H01M 8/10

(52) U.S. Cl. 429/30

(57) ABSTRACT

Each of collectors 22 of an electrode structure 20, which partially constitutes a polymer electrolyte fuel cell, is formed from a metal lath MR having a large number of through-holes. A stopping portion 22a in which the through-holes are reduced in diameter is formed at a peripheral end portion of the collector 22. The peripheral end portion of the collector 22 is folded; subsequently, the folded peripheral end portion is pressed, thereby forming the stopping portion 22a. A resin seal portion 23 for sealing introduced fuel gas and oxidizer gas is formed integrally with the stopping portions 22a by insert molding which is performed such that an injected molten resin encloses the stopping portions 22a. The resin seal portion 23 formed integrally with the stopping portions 22a can reliably prevent inflow of the molten resin toward central portions of the collectors 22.

### TECHNICAL FIELD

The present invention relates to a fuel cell, and more particularly to a polymer electrolyte fuel cell.

### BACKGROUND ART

Conventionally known polymer electrolyte fuel cells are disclosed in, for example, Japanese Patent Application Laid-Open (kokai) Nos. 2002-184422 and 2005-317322. The conventional polymer electrolyte fuel cells employ a cell structure. In the cell structure, a membrane-electrode assembly (MEA) and metal plates having projections (or collectors having channels) are disposed between two carbon plates (or two separator plates); the membrane-electrode assembly (MEA) includes an electrolyte membrane (electrolyte), an anode electrode, and a cathode electrode; and a seal (frame) is disposed around the metal plates (or collectors). In the cell structure, a space is defined by a surface of the membrane-electrode assembly (MEA), an inner peripheral wall of the seal (frame), and a surface of each of the carbon plates (separator plates). The metal plates (collectors) are accommodated in the thus-formed corresponding spaces, thereby forming gas passageways through which fuel gas and oxidizing gas flow.

As mentioned above, in order to form spaces through which introduced fuel gas and oxidizing gas flow, the conventional polymer electrolyte fuel cells require employment of the seal (frame). This involves a problem of an increase in the number of components of a fuel cell stack, which is formed by stacking a large number of cells together. The seal (frame) also has a function of preventing leakage of introduced fuel gas and oxidizing gas to the exterior of a cell. An increase in the number of components deteriorates workability of assembly. For example, assembly work is performed as follows: the seal (frame) is positioned on and then bonded to the membrane-electrode assembly (MEA); then, the metal plates (collectors) are received in corresponding receptacle portions of the seal (frame); subsequently, the carbon plates (separator plates) are bonded to the seal (frame). Such a deterioration in workability of assembly causes difficulty in improving productivity of fuel cells.

A conventionally known polymer electrolyte fuel cell which copes with the above problem is disclosed in, for example, Japanese Patent Application Laid-Open (kokai) No. 2005-209607. In the conventional polymer electrolyte fuel cell, a resin portion is formed integrally with an outer periphery of an electrically conductive porous member by, for example, insert molding. Thus, this can be expected to solve the above-mentioned problem; i.e., to lower the number of components and to improve workability of assembly.

### DISCLOSURE OF THE INVENTION

However, generally, in the case where a resin portion is formed integrally with a porous member through injection of a molten resin, the molten resin flows into the porous member in the course of molding, possibly filling a large number of pores formed in the porous member. As a result, introduced fuel gas and oxidizing gas may fail to be favorably supplied to a membrane-electrode assembly (MEA), potentially causing a drop in the efficiency of electricity generation in the fuel cell. In this connection, in order to prevent inflow of the molten resin into the porous member, Japanese Patent Application Laid-Open (kokai) No. 2005-209607 discloses measures to lower fluidity of the molten resin; for example, when a thermoplastic resin is used, a mold surface in contact with the porous member is cooled; and when a thermosetting resin is used, the mold surface is heated.

However, the disclosed measures are not perfect. Specifically, for example, in some cases, in association with variations among lots in physical properties of resin pellets to be used, variations arise in the temperature of cooling or heating for lowering the fluidity. Also, in some cases, the pore size varies among porous members to be used. In such a case, the fluidity of the molten resin cannot be properly controlled, resulting in a possible failure to prevent inflow of the molten resin into the porous member.

The present invention has been achieved for solving the above problems, and an object of the invention is to provide a polymer electrolyte fuel cell having collectors which are formed from a porous material and with which a resin seal member is formed integrally in such a manner that inflow of a molten resin into the collectors is reliably prevented.

To achieve the above object, according to a feature of the present invention, there is provided a polymer electrolyte fuel cell comprising a plurality of separators for preventing mixing of externally introduced fuel gas and oxidizer gas, and electrode structures disposed between the separators. Each of the electrode structures has a membrane-electrode assembly and collectors. The membrane-electrode assembly is configured such that an anode electrode layer and a cathode electrode layer are formed integrally with a predetermined electrolyte membrane. The collectors are superposed respectively on the anode electrode layer and the cathode electrode layer and adapted to supply the fuel gas introduced via the corresponding separator to the anode electrode layer in a diffused manner and the oxidizer gas introduced via the corresponding separator to the cathode electrode layer in a diffused manner and to collect electricity generated through electrode reactions in the membrane-electrode assembly. Each of the collectors is formed from a plate-like porous material having a large number of through-holes and has a hole-diameter-reduced portion which is formed at a peripheral end portion of the collector and in which the through-holes are reduced in diameter. Each electrode structure has a resin seal member adapted to seal the introduced fuel gas and oxidizer gas. The resin seal member is formed by insert molding performed such that an injected molten resin encloses the hole-diameter-reduced portions at the peripheral end portions of the collectors. In this case, the plate-like porous material may be, for example, a metal lath in which a large number of though-holes are formed in a meshy, step-like arrangement.

According to the present invention, each of the collectors formed from a plate-like porous material having a large number of through-holes (e.g., metal lath) allows formation, at its peripheral end portion, of the hole-diameter-reduced portion in which the through-holes are reduced in diameter. Also, the resin seal member is formed by insert molding which is performed such that the an injected molten resin encloses the hole-diameter-reduced portions. By virtue of forming the hole-diameter-reduced portion on each of the collectors, inflow of a molten resin associated with the insert molding from the peripheral end portion of the collector toward a central portion of the collector can be reliably prevented. This reliably and properly secures gas passageways for supplying fuel gas and oxidizer gas to the anode electrode layer and the cathode electrode layer, respectively. Therefore, there can be reliably avoided a drop in electricity generation performance which would otherwise result from lack of supply of fuel gas and oxidizer gas during operation of the fuel cell. Notably, the term “plate-like” used in connection with a plate-like porous material encompasses, for example, a shape having irregularities.

The hole-diameter-reduced portion of each of the collectors may be formed, for example, by subjecting to press working the peripheral end portion of the collector. More specifically, the hole-diameter-reduced portion of each of the collectors may be formed, for example, by subjecting to press working the peripheral end portion in a folded condition of the collector. Also, the hole-diameter-reduced portion of each of the collectors may be formed, for example, by subjecting to press working the peripheral end portion of the collector together with a strip of the plate-like porous material superposed on the peripheral end portion. These methods can form the hole-diameter-reduced portion at the peripheral end portion of each of the collectors without need to employ special working and thus can greatly improve productivity.

Also, the hole-diameter-reduced portion of each of the collectors may be formed, for example, by subjecting the peripheral end portion of the collector to press working which acts on straightly extending partial areas of the peripheral end portion. Preferably, the hole-diameter-reduced portion of each of the collectors is formed, for example, by subjecting the peripheral end portion of the collector to press working which acts on straightly extending staggered areas of the peripheral end portion. By these methods, for example, straightly extending hole-diameter-reduced portions each having a notch-shaped cross section are formed in portions of the peripheral end portion of each of the collectors. The straight hole-diameter-reduced portions can prevent inflow of a molten resin and allow a reduction in the area of press-working on each of the collectors; as a result, variation of thickness of each of the collectors (more specifically, variation of thickness of a central portion of the collector) associated with formation of the hole-diameter-reduced portion can be restrained, whereby gas passageways for fuel gas and oxidizer gas can be favorably secured.

Even when a molten resin is injected at high pressure for insert molding, staggered arrangement of the straightly extending hole-diameter-reduced portions can effectively prevent inflow of the molten resin. Also, staggered arrangement of the straight hole-diameter-reduced portions can restrain lateral flow of fuel gas and oxidizer gas flowing through the corresponding collectors (more specifically, flow of gas without direct contact with the anode electrode layer and the cathode electrode layer). Therefore, externally introduced fuel gas and oxidizer gas can be efficiently supplied to the anode electrode layer and the cathode electrode layer, respectively.

According to another feature of the present invention, each of the collectors has a cover to prevent inflow of a molten resin associated with the insert molding from the peripheral end portion of the collector toward a central portion of the collector, and the hole-diameter-reduced portion of each of the collectors is formed in association with caulking of the cover to the peripheral end portion of the collector. According to this feature, provision of the cover at the peripheral end portion of each of the collectors can more reliably prevent inflow of a molten resin, and formation of the hole-diameter-reduced portion at the peripheral end portion of each of the collectors can restrain, for example, lateral flow of fuel gas and oxidizer gas. Therefore, externally introduced fuel gas and oxidizer gas can be efficiently supplied to the anode electrode layer and the cathode electrode layer, respectively.

According to a further feature of the present invention, the resin seal member formed by the insert molding has a thickness substantially equal to a thickness of a central portion of each of the collectors. This facilitates an operation of assembling (e.g., bonding) the membrane-electrode assembly and the collector having the integrally formed resin seal member together and an operation of assembling (e.g. bonding) the collector and the separator together. In this case, more preferably, the thickness of the resin seal member formed by the insert molding is slightly smaller than the thickness of a central portion of the collector. This establishes a good state of contact between the membrane-electrode assembly and the collector and that between the collector and the separator. This reduces resistance associated with collection, by each of the collectors, of electricity generated through electrode reactions in the membrane-electrode assembly and resistance associated with conduction of collected electricity from each of the collectors to the corresponding separator. As a result, output from the fuel cell can be favorably maintained.

### BRIEF DESCRIPTION OF THE DRAWINGS

FIG. 1 is a schematic sectional view showing a portion of a fuel cell stack using collectors according to an embodiment of the present invention.

FIG. 2 is a schematic perspective view showing a separator of FIG. 1.

FIG. 3 is a sectional view for explaining an electrode structure of FIG. 1.

FIGS. 4(a) and 4(b) are views for explaining a metal lath used to form the collector.

FIGS. 5(a) and 5(b) are views schematically showing a stopping-portion-forming process for forming a stopping portion of the collector according to the embodiment, wherein FIG. 5(a) is a view schematically showing a bending step for folding a peripheral end portion of the collector, and FIG. 5(b) is a view schematically showing a pressing step for pressing the folded peripheral end portion.

FIG. 6 is a view schematically showing a resin molding process for insert-molding a resin seal portion.

FIG. 7 is a view for explaining a modification of the embodiment.

FIG. 8 is a schematic view for explaining a collector according to a first modification of the present invention.

FIG. 9 is a schematic view for explaining a stopping-portion-forming process according to the first modification.

FIG. 10 is a schematic view for explaining a resin molding process according the first modification.

FIG. 11 is a schematic view for explaining a further modification of the first modification.

FIG. 12 relates to a second modification of the present invention, and is a schematic view for explaining a cover to be attached to the collector.

FIG. 13 is a schematic view for explaining a state of attachment of the cover of FIG. 12.

### BEST MODE FOR CARRYING OUT THE INVENTION

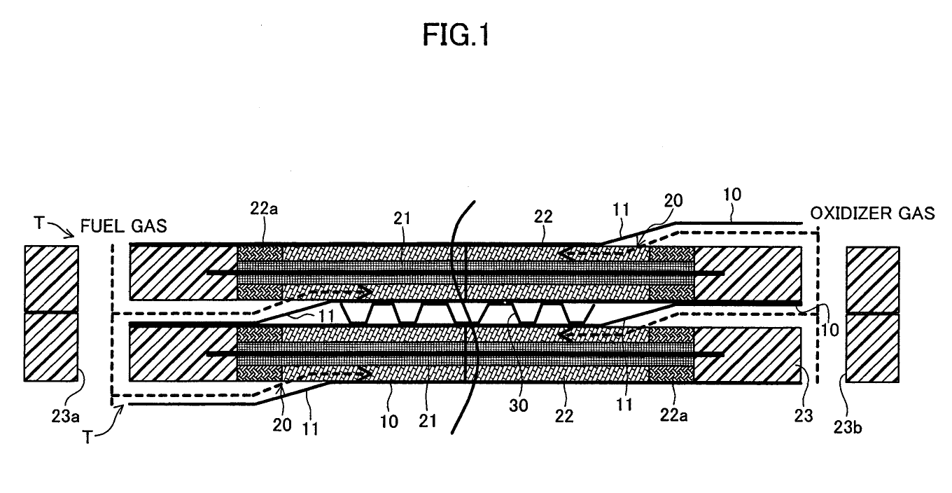

An embodiment of the present invention will next be described in detail with reference to the drawings. FIG. 1 is a sectional view schematically showing a portion of a polymer electrolyte fuel cell stack according to an embodiment of the present invention. The fuel cell stack has cells T. Each of the cells T includes a pair of fuel cell separators 10 (hereinafter, referred to merely as separator(s) 10) and an electrode structure 20 disposed between the separators 10. The fuel cell stack is configured such that a large number of the cells T are stacked while cooling water channels 30 are sandwiched between the cells T.

In the thus-configured fuel cell stack, fuel gas, such as hydrogen gas, and oxidizer gas, such as air, are externally introduced to the cells T, thereby generating electricity through electrode reactions in the electrode structures 20. Hereinafter, fuel gas and oxidizer gas may be collectively called gas.

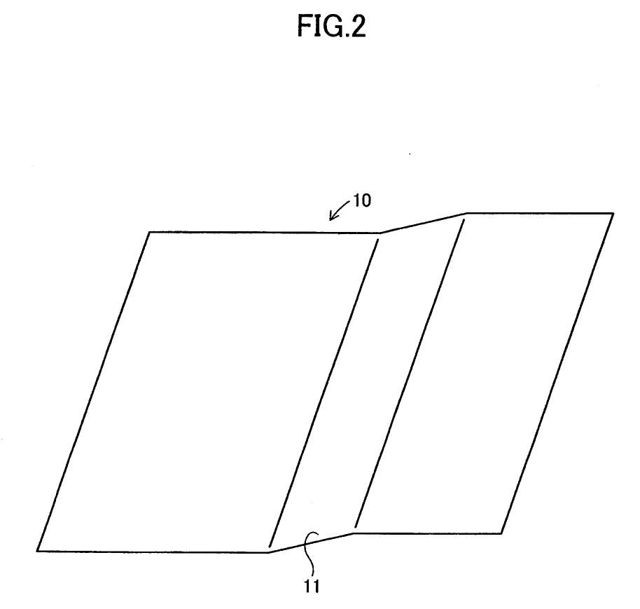

The separators 10 are adapted to supply gas to the electrode structures 20 while preventing mixing of fuel gas and oxidizer gas introduced from the exterior of the fuel cell stack, and to output electricity generated through electrode reactions in the electrode structures 20 to the exterior of the fuel cell stack. Therefore, each of the separators 10 is formed from an electrically conductive metal sheet (e.g., a stainless steel sheet), and has, as schematically shown in FIG. 2, a stepped portion 11 biased toward its one end.

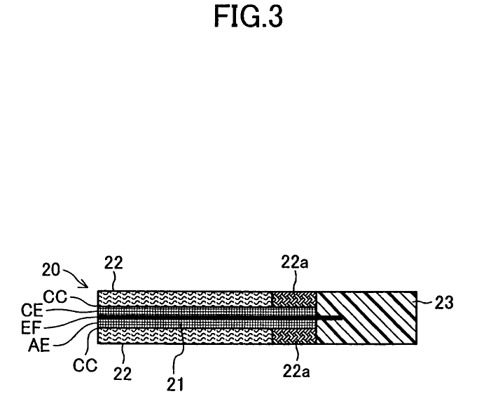

As partially shown in FIG. 3, the electrode structure 20 includes an MEA (Membrane Electrode Assembly) 21 which carries out electrode reactions by use of externally introduced fuel gas and oxidizer gas. Major components of the MEA 21 are an electrolyte membrane EF, an anode electrode layer AE, and a cathode electrode layer CE. The anode electrode layer AE is formed by superposing a layer of a predetermined catalyst on one side of the electrolyte membrane EF toward which fuel gas is introduced. The cathode electrode layer CE is formed by superposing a layer of a predetermined catalyst on the other side of the electrolyte membrane EF toward which oxidizer gas is introduced. Actions (i.e., electrode reactions) of the electrolyte membrane EF, the anode electrode layer AE, and the cathode electrode layer CE are well known and are not directly related to the present invention; thus, detailed description thereof is omitted. The outer side of the anode electrode layer AE and the outer side of the cathode electrode layer CE of the MEA 21 are covered with respective carbon cloths CC, which are of electrically conductive fibers. The MEA 21 may be configured without use of the carbon cloths CC, as needed.

The electrode structure 20 includes a pair of collectors 22, between which the MEA 21 is sandwiched and which appropriately diffuse fuel gas and oxidizer gas introduced via the separators 10 and collect electricity generated through electrode reactions. As shown in FIG. 4(a), each of the collectors 22 is formed from a metal sheet (hereinafter called a metal lath MR) in which a large number of through-holes (each having a substantially hexagonal shape in FIG. 4(a)) of small diameter are formed in a meshy arrangement. The metal lath MR is formed from, for example, a metal sheet (preferably, a stainless steel sheet or the like) having a thickness of about 0.1 mm, and the large number of through-holes formed in the metal lath MR each have a diameter of about 0.1 mm to 1 mm. As shown in FIG. 4(b), which is a side view as viewed from the left-right direction of FIG. 4(a), portions which form respective through-holes are connected in a sequentially overlapping manner, and in a step-like arrangement as viewed in section. The metal lath MR can be formed by a known manufacturing method. Therefore, the description of how the metal lath MR is formed is omitted.

As shown in FIG. 3, each of the collectors 22 has a stopping portion 22a at a peripheral end portion of the metal lath MR having a rectangular shape and a size appropriate for forming the cell T. The stopping portion 22a is a hole-diameter-reduced portion in which the through-holes arranged in a meshy manner are crushed to thereby be reduced in diameter. As will be described later, the stopping portion 22a is formed for the purpose of preventing inflow of a molten resin toward central portions of the collectors 22 at the time of insert-molding a resin seal portion 23 adapted to unitarily fix the MEA 21 and the collectors 22 together and to prevent leakage of introduced fuel gas and oxidizer gas. A stopping-portion-forming process for forming the stopping portion 22a will next be described in detail.

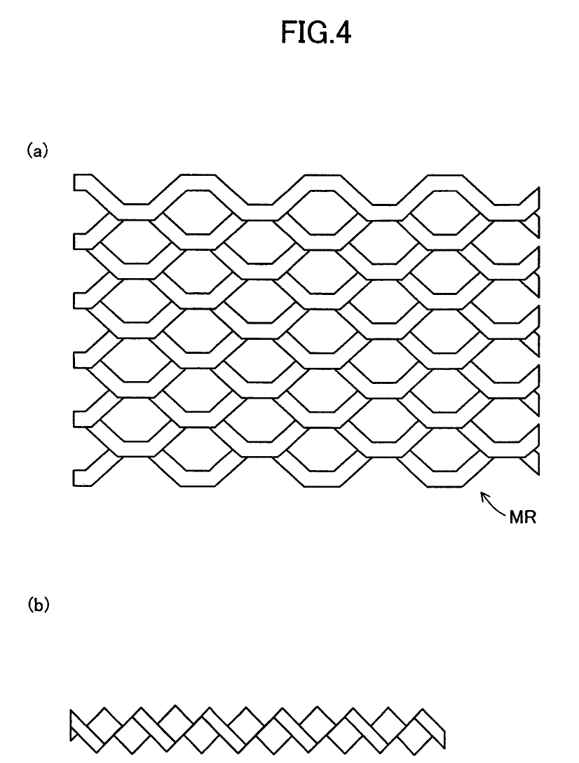

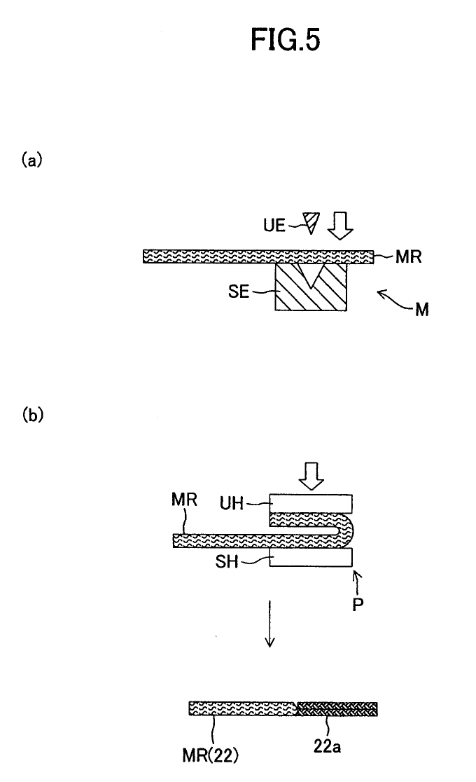

As schematically shown in FIGS. 5(a) and 5(b), the stopping-portion-forming process consists of a bending step for folding a peripheral end portion of the metal lath MR, and a pressing step for pressing together the folded peripheral end portion and a major portion of the metal lath MR so as to crush the through-holes arranged in a meshy manner, thereby forming the stopping portion 22a. As shown in FIG. 5(a), in order to fold the peripheral end portion of the metal lath MR, the bending step mainly uses a bending machine M having an upper die UE having an angular head, and a lower die SE having a V-shaped cavity for receiving the upper die UE together with a portion of the metal lath MR.

In the bending step, first, a rectangular metal lath MR having a predetermined size is placed on the lower die SE. Next, the upper die UE is lowered toward the metal lath MR placed on the lower die SE until the angular head of the upper die UE touches the metal lath MR. In this condition, the upper die UE is further lowered so as to move the angular head of the upper die UE, together with a portion of the metal lath MR, into the cavity of the lower die SE. Pressing the angular head of the upper die UE against the surface of a portion of the metal lath MR causes the portion of the metal lath MR to begin to be deformed toward the cavity of the lower die SE. Accordingly, as the upper die UE lowers, a peripheral end portion of the metal lath MR is acutely bent toward the upper die UE. Then, the upper die UE is raised for retreat. Subsequently, the acutely bent portion of the metal lath MR is further bent toward the major portion of the metal lath MR, thereby completing the bending step. In the following description, the metal lath MR whose peripheral end portion is folded is called a folded workpiece.

Next, the folded workpiece is conveyed to the pressing step. In the pressing step, as shown in FIG. 5(b), the stopping portion 22a is formed by use of an ordinary press P having a flat upper die UH and a flat lower die SH. In the pressing step, when the folded workpiece is placed on the lower die SH, the upper die UH lowers and selectively presses the folded portion of the folded workpiece for crushing. At this time, the upper die UH presses the folded portion of the folded workpiece such that a resultant peripheral end portion of the metal lath MR has a thickness slightly greater than that of the major portion (central portion) of the metal lath MR. As a result, in the pressed portion; i.e., the peripheral end portion of the metal lath MR, through-holes are crushed. Thus is formed the collector 22 having the stopping portion 22a.

Then, while the MEA 21 is sandwiched between the two collectors 22 (hereinafter, the resultant assembly is called a primary assembly), the resin seal portion 23 is formed integrally with the stopping portions 22a of the collectors 22, thereby forming the electrode structure 20. The resin seal portion 23 has a function of introducing fuel gas and oxidizer gas supplied from the exterior of the fuel cell stack to the cell T and, as will be described later, a function of sealing introduced fuel gas and oxidizer gas in corresponding spaces between the electrode structure 20 and the separators 10, the electrode structure 20 being sandwiched between the separators 10.

As shown in FIG. 1, the resin seal portion 23 has a through-hole 23a for introducing fuel gas and a through-hole 23b for introducing oxidizer gas. Although unillustrated, in some cases, the resin seal portion 23 has through-holes (discharge ports) for discharging introduced gas to the exterior of the fuel cell. As will be described later, the resin seal portion 23 has a thickness substantially equal to (more preferably, slightly smaller than) that of the primary assembly in order to ensure sealing when fuel gas and oxidizer gas are introduced to the electrode structure 20, and to efficiently output electricity generated in the MEA 21 to the exterior of the fuel cell via the collectors 22 and the separators 10. Next will be described a resin molding process for forming the resin seal portion 23.

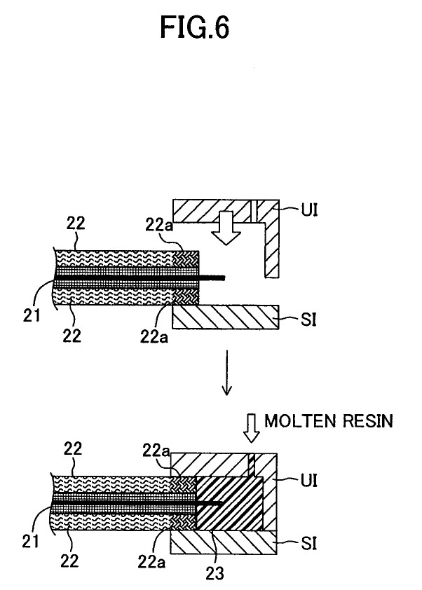

The resin molding process forms, by insert molding, the resin seal portion 23 integrally with a peripheral end portion of the primary assembly; more specifically, integrally with the stopping portions 22a of the collectors 22. As schematically shown in FIG. 6, the resin molding process forms the resin seal portion 23 by use of an insert molding die having a lower die SI on which the primary assembly is placed, and an upper die UI into which the peripheral end portion of the primary assembly is inserted and through which a molten resin is injected. Specifically, in the resin molding process, first, the primary assembly is placed on the lower die SI of the insert molding die. Next, the upper die UI of the insert molding die is lowered, and die clamping is carried out so as to deform the peripheral end portion of the primary assembly with the wall of a cavity formed in the upper die UI in such a manner that the peripheral end portion of the primary assembly has a thickness slightly smaller than that of a major portion of the primary assembly. Then, a molten resin is injected under a predetermined pressure through a runner formed in the upper die UI. A resin to be injected may be one capable of sealing externally introduced fuel gas (hydrogen gas) and oxidizer gas (air) and capable of enduring heat generated in association with electrode reactions. Specifically, a thermosetting resin (e.g., glass epoxy resin) or an elastomer resin may be employed.

In formation of the resin seal portion 23, the stopping portions 22a favorably prevent inflow of a molten resin injected through the runner toward a central portion of the primary assembly (more specifically, central portions of the collectors 22). That is, as mentioned above, the pressing step crushes through-holes in peripheral end portions of the collectors 22, and the upper die of the insert molding die further deforms the peripheral end portions of the collectors 22; thus, through-holes in the stopping portions 22a of the collectors 22 are completely crushed. Therefore, the molten resin injected into the cavity can be prevented from flowing inward beyond the stopping portions 22a.

As described above, through undergoing the stopping-portion-forming process and the resin molding process, the primary assembly has the resin seal portion 23 formed integrally therewith, thereby yielding the electrode structure 20. The thus-formed electrode structure 20 is disposed between the two separators 10 as shown in FIG. 1, and, for example, the separators 10 and the resin seal portion 23 are bonded together by use of adhesive, thereby forming the cell T. At this time, the resin seal portion 23 has a thickness substantially equal to or slightly smaller than that of the electrode structure 20. Therefore, when the separators 10 are bonded to the resin seal portion 23, the separators 10 press the corresponding collectors 22 toward the MEA 21. This establishes a good state of contact between the MEA 21 and the collectors 22 and a good state of contact between the collectors 22 and the corresponding separators 10.

A predetermined number of cells T are stacked such that the cooling water channels 30 are disposed between the cells T; more specifically, the cooling water channels 30 are disposed in a space formed between the cells T by the mutually facing separators 10, thereby forming a fuel cell stack. As shown in FIG. 1, the cooling water channels 30 are a large number of alternately inverted channels. Cooling water is introduced through an unillustrated inlet, flows through the alternately inverted channels, and is discharged through an unillustrated outlet.

By means of disposing the cooling water channels 30 between the separators 10, heat generated through electrode reactions in the MEAs 21 of the electrode structures 20 can be efficiently removed. Specifically, heat generated through electrode reactions in the MEAs 21 is conducted to the separators 10 via the collectors 22. Meanwhile, since the separators 10 are in contact with cooling water flowing through the cooling water channels 30, heat of reaction conducted to the separators 10 via the collectors 22 can be released to the cooling water. Therefore, heat generated through electrode reactions can be efficiently removed, whereby the electrode structures 20 can be efficiently cooled.

As shown in FIG. 1, in the thus-formed fuel cell stack, externally supplied fuel gas is supplied to the cells T via the through-holes 23a formed in the resin seal portions 23, and externally supplied oxidizer gas is supplied to the cells T via the through-holes 23b formed in the resin seal portions 23. Fuel gas is introduced to the anode electrode layer AE side of the electrode structures 20 via the stepped portions 11 of the separators 10 communicating with the through-holes 23a, and oxidizer gas is introduced to the cathode electrode layer CE side of the electrode structures 20 via the stepped portions 11 of the separators 10 communicating with the through holes 23b.

Thus-introduced fuel gas and oxidizer gas flow through a large number of through-holes formed in the collectors 22 in a meshy arrangement, thereby being appropriately diffused and supplied to the anode electrode layer AE and the cathode electrode layer CE, respectively. Since the stopping portions 22a of the collectors 22 have prevented inflow of resin at the time of forming the resin seal portion 23, central portions of the collectors 22 have sufficient space for flow of gas. As a result, sufficient fuel gas can be supplied to the anode electrode layer AE, and sufficient oxidizer gas can be supplied to the cathode electrode layer CE. Therefore, the fuel cell can exhibit excellent electricity generation performance.

Furthermore, the MEA 21 and the collectors 22 are in a good state of contact, and the collectors 22 and the corresponding separators 10 are in a good state of contact; thus, electricity generated through electrode reactions in the MEA 21 can be efficiently output to the exterior of the fuel cell. That is, a good state of contact of the collectors 22 with the MEA 21 and with the corresponding separators 10 increases the area of contact between the members. Therefore, resistance associated with collection of electricity generated in the MEA 21 (electricity collection resistance) can be greatly reduced, so that generated electricity can be efficiently collected; i.e., electricity can be collected with improved efficiency of electricity collection.

As is understood from the above description, according to the above embodiment, the collector 22 formed from the metal lath MR having a large number of through-holes allows formation, at its peripheral end portion, of the stopping portion 22a, which serves as a hole-diameter-reduced portion. Also, the resin seal portion 23 can be formed integrally with the stopping portions 22a by insert molding which is performed such that the stopping portions 22a are inserted into a die cavity. By virtue of forming the stopping portion 22a on the collector 22, inflow of a molten resin toward central portions of the collectors 22 associated with the insert molding can be reliably prevented. This reliably and properly secures gas passageways for supplying fuel gas and oxidizer gas to the anode electrode layer AE and the cathode electrode layer CE, respectively. Therefore, there can be reliably avoided a drop in electricity generation performance which would otherwise result from lack of supply of fuel gas and oxidizer gas during operation of the fuel cell.

The stopping portion 22a can be formed by subjecting to press working a peripheral end portion of the collector 22. Therefore, the stopping portion 22a can be formed at the peripheral end portion of the collector 22 without need to employ special working, so that productivity can be greatly improved.

By means of the resin seal portion 23 having a thickness substantially equal to or slightly smaller than that of the collector 22, a good state of contact can be established between the MEA 21 and the collectors 22 and between the collectors 22 and the corresponding separators 10. This can reduce contact resistance associated with collection, by the collectors 22, of electricity generated through electrode reactions in the MEA 21 and contact resistance associated with conduction of collected electricity from the collectors 22 to the corresponding separators 10. As a result, output from the fuel cell can be favorably maintained.

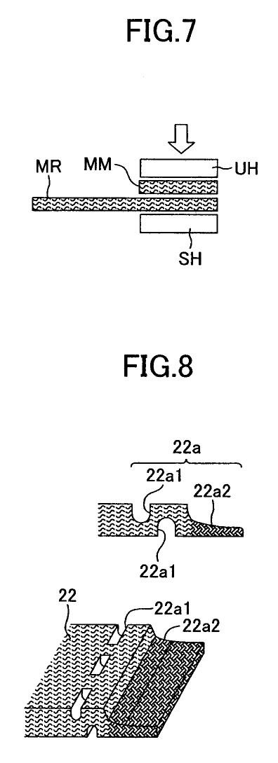

According to the above embodiment, in the stopping-portion-forming process, a peripheral end portion of the metal lath MR is subjected to the bending step, and the pressing step follows, thereby forming the stopping portion 22a. However, the bending step may be eliminated from the stopping-portion-forming process in forming the stopping portion 22a. Specifically, as schematically shown in FIG. 7, a strip of metal lath having dimensions corresponding to the stopping portion 22a (hereinafter called a stopping metal lath MM) is prepared. The stopping metal lath MM is superposed on a peripheral end portion of the metal lath MR. The stopping metal lath MM and the peripheral end portion of the metal lath MR arranged in layers are subjected to the above-mentioned pressing step, whereby the stopping portion 22a similar to that of the above embodiment can be formed. Even in this case, similar effect as in the case of the above embodiment can be expected, and productivity of the collectors 22 can be improved.

According to the above embodiment, in the stopping-portion-forming process, a peripheral end portion of the metal lath MR is subjected to the bending step, and the pressing step follows, thereby forming the stopping portion 22a. However, for example, for a certain type of resin used to form the resin seal portion 23, a molten resin may be injected into a die cavity with high injection pressure. In this case, if, as in the case of the above embodiment, through-holes in the metal lath MR are crushed merely by press working, high injection pressure may cause the molten resin to pass through the stopping portion 22a, resulting in inflow of the molten resin toward a central portion of the collector 22. Therefore, it is desirable to form the stopping portion 22a capable of more reliably preventing inflow of a molten resin. Next will be described a first modification for forming the stopping portion 22a capable of more effectively preventing inflow of a molten resin. In the description of the first modification, features similar to those of the above embodiment are denoted by like reference numerals, and detailed description thereof is omitted.

Even in the first modification, the collector 22 is formed from the metal lath MR. As shown in FIG. 8, the stopping portion 22a according to the first modification is composed of a notch formed portion 22a1 and a crushed portion 22a2. The notch formed portion 22a1 is formed in the vicinity of a peripheral end portion of the metal lath MR and includes a plurality of straight notches which each have a U-shaped cross section and are arranged in a staggered manner. The crushed portion 22a2 is formed externally of the notch formed portion 22a1; i.e., at the peripheral end portion of the metal lath MR, by crushing meshy through-holes in the peripheral end portion of the metal lath MR.

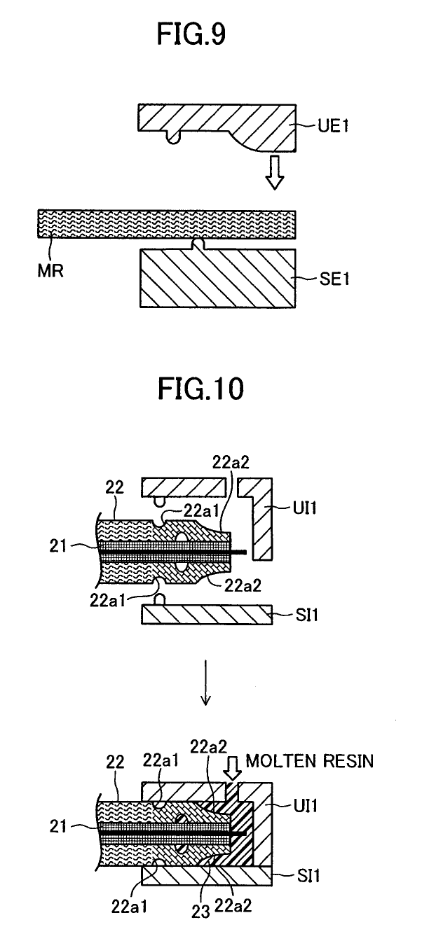

The notch formed portion 22a1 and the crushed portion 22a2 are simultaneously formed by carrying out a stopping-portion-forming process according to the first modification. As schematically shown in FIG. 9, the stopping-portion-forming process according to the first modification simultaneously forms the notch formed portion 22a1 and the crushed portion 22a2 by use of a press equipped with an upper die UE1, which has projections for forming the notch formed portion 22a1 on the upper side of the metal lath MR and a bulge for forming the crushed portion 22a2, and a lower die SE1, which has projections for forming the notch formed portion 22a1 on the lower side of the metal lath MR.

Specifically, first, the metal lath MR having a rectangular shape and a predetermined size is fed on the lower die SE1. Next, the upper die UE1 is lowered toward the metal lath MR placed on the lower die SE1 until the bulge of the upper die UE1 touches the metal lath MR. In this condition, the upper die UE1 is further lowered, whereby the bulge of the upper die UE1 presses the peripheral end portion of the metal lath MR, and through-holes in the peripheral end portion begin to be crushed. Meanwhile, when the bulge of the upper die UE1 presses the peripheral end portion of the metal lath MR, the projections of the upper die UE1 begin to press the upper side of the metal lath MR, and the projections of the lower die SE1 begin to press the lower side of the metal lath MR. When the upper die UE1 lowers to a predetermined position in relation to the lower die SE1, the notch formed portion 22a1 and the crushed portion 22a2 are simultaneously formed, thereby yielding the collector 22 having the stopping portion 22a.

As in the case of the above embodiment, the MEA 21 and two collectors 22 each having the stopping portion 22a constitute a primary assembly. The resin seal portion 23 is formed integrally with the stopping portions 22a of the collectors 22 of the primary assembly, thereby yielding the electrode structure 20. As described below, the resin molding process according to the first modification slightly differs from that according to the above embodiment.

As schematically shown in FIG. 10, the resin molding process according to the first modification uses an insert-molding die whose lower die SI1 and upper die UI1 have projections corresponding to the notches of the notch formed portions 22a1 formed at the stopping portions 22a of the collectors 22. When the primary assembly is placed on the lower die SI1, the projections formed on the lower die SI1 are fitted into the corresponding notches of the notch formed portion 22a1 of the lower collector 22. When the upper die UI1 lowers, the projections formed on the upper die UI1 are fitted into the corresponding notches of the notch formed portion 22a1 of the upper collector 22. In this condition, die clamping is carried out. Then, a molten resin is injected with a predetermined injection pressure through a runner formed in the upper die UI1.

As compared with the case of the above embodiment, formation of the resin seal portion 23 according to the first modification can more favorably prevent inflow of the molten resin injected through the runner toward central portions of the collectors 22. Specifically, according to the first modification, as mentioned above, the stopping portion 22a is composed of the notch formed portion 22a1 and the crushed portion 22a2. Thus, as in the case of the above embodiment, the crushed portions 22a2 prevent inflow of the molten resin injected through the runner of the upper die UI1 toward central portions of the collectors 22. Furthermore, the notches which are formed in a staggered arrangement in the notch formed portion 22a1 also prevent inflow of the molten resin. More specifically, the molten resin is injected in a condition in which the projections of the upper and lower dies UI1 and SI1 are fitted into the corresponding notches of the notch formed portion 22a1. Therefore, for example, even when the molten resin is injected with high injection pressure, the projections of the upper and lower dies UI1 and SI1 obstruct the molten resin; as a result, inflow of the molten resin toward central portions of the collectors 22 can be more reliably prevented.

According to the first modification, insert molding is carried out in a condition in which the projections of the upper and lower dies UI1 and SI1 are fitted into those notches of the notch formed portions 22a1 which are formed on the first sides of the metal laths MR. In this case, a portion of the molten resin having passed through the crushed portions 22a2 is solidified in notches formed on the second sides of the metal laths MR. By virtue of this, for example, when gas is externally introduced into the cells T of a fuel cell stack, resin solidified in the notches prevents lateral flow of gas flowing through the collectors 22. Therefore, even in the first modification, similar effect as in the case of the above embodiment can be yielded.

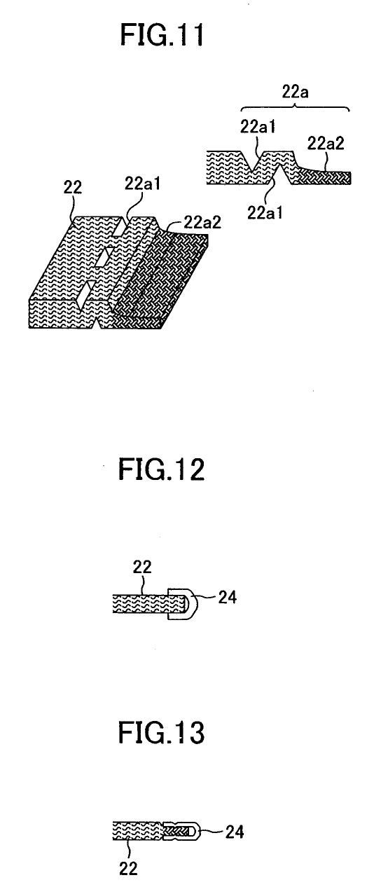

According to the above first modification, notches of the notch formed portion 22a1 each have a substantially U-shaped cross section. However, as schematically shown in FIG. 11, each of the notches may have a substantially V-shaped cross section. Even when the notch formed portion 22a1 is formed such that notches formed therein each have a substantially V-shaped cross section, similar effect as in the case of the above first modification can be expected.

According to the above first modification, in the stopping-portion-forming process, the notch formed portion 22a1 and the crushed portion 22a2 are formed, and, in the subsequent resin molding process, the resin seal portion 23 is formed while the projections of the upper and lower dies UI1 and SI1 are fitted into the corresponding notches. As mentioned above, since the notch formed portion 22a1 can obstruct flow of a molten resin, the crushed portion 22a2 can be eliminated. In this case, the stopping-portion-forming process can be eliminated, and formation of the notch formed portion 22a1 and insert molding of the resin seal portion 23 can be simultaneously carried out in the resin molding process. Notably, in this case, notches in the notch formed portion 22a1 may be formed at narrowed intervals.

Specifically, in the resin molding process, a primary assembly in which the MEA 21 is sandwiched between the rectangular metal laths MR each having a predetermined size is placed on the lower die SI1 subsequently, the upper die UI1 is lowered to carry out die clamping. As a result, the projections of the upper die UI1 crush corresponding portions of the upper side of the upper metal lath MR, and the projections of the lower die SI1 crush corresponding portions of the lower side of the lower metal lath MR, thereby forming notches of the notch formed portions 22a1 as in the case of the above first modification. In this state, a molten resin is injected whereby the resin seal portion 23 is integrally formed. Therefore, in this case, effect equivalent to that of the above first modification can be expected; additionally, since the stopping-portion-forming process can be eliminated, productivity can be greatly improved. Also, since only notches of the notch formed portion 22a1 are formed in the collector 22, large deformation is not involved. This restrains variation of thickness of the collector 22 associated with formation of the notches, so that a gas passageway can be favorably secured.

According to the above first modification, the resin seal portion 23 is insert-molded to the primary assembly composed of the MEA 21 and a pair of the collectors 22. However, the following method can also be possible: each of the two collectors 22 is inserted into a cavity defined by the upper die UI1 and the lower die SI1, and the resin seal portion 23 is insert-molded to each of the collectors 22. Thus, the projections of the upper and lower dies UI1 and SI1 can be fitted into corresponding notches of the notch formed portion 22a1, which notches are formed on the upper and lower sides of the metal lath MR in a staggered arrangement, so that flow of a molten resin can be more reliably obstructed. In this case, the MEA 21 may be sandwiched between the collectors 22 to which the respective mold seal portions 23 are molded, thereby forming the cell T.

According to the above first modification, notches are formed in a staggered arrangement, thereby forming the notch formed portion 22a1. However, for example, a straight notch may be continuously formed along one end of the metal lath MR having a predetermined size. Even in this case, similar effect as in the case of the above first modification can be expected, since the straightly formed notch can obstruct flow of a molten resin.

The above embodiment uses the collector 22 whose stopping portion 22a is formed by crushing through-holes in a peripheral end portion of the metal lath MR. The stopping portion 22a prevents inflow of a molten resin toward a central portion of the collector 22 at the time of forming the resin seal portion 23 by insert-molding. In place of or in addition to this, a cover for preventing inflow of a molten resin can be attached to a peripheral end portion of the rectangular metal lath MR having a predetermined size. This second modification will next be described in detail. In the description of the second modification, features similar to those of the above embodiment are denoted by like reference numerals, and detailed description thereof is omitted.

Even in the second modification, the collector 22 is formed from the metal lath MR. According to the second modification, as shown in FIG. 12, a cover 24 is attached to a peripheral end portion of the metal lath MR, thereby forming the collector 22. The cover 24 is formed from a metal sheet (e.g., a stainless steel sheet) and has a cross section resembling a squarish letter U.

The cover 24 undergoes a cover-attaching process corresponding to the stopping-portion-forming process in the above embodiment, thereby being attached to the metal lath MR. More specifically, the cover 24 attached to a peripheral end portion of the metal lath MR is subjected to known caulking, whereby, as shown in FIG. 13, the cover 24 is attached to the metal lath MR. At this time, in association with caulking of the cover 24 to the metal lath MR, through-holes in the peripheral end portion of the metal lath MR are crushed.

The MEA 21 and two collectors 22 each having the cover 24 attached to its peripheral portion constitute a primary assembly. The resin seal portion 23 is integrally formed along the covers 24 of the collectors 22 of the primary assembly, thereby yielding the electrode structure 20. Even in the second modification, the resin seal portion 23 is insert-molded to the peripheral end portion of the collector 22 by the resin molding process similar to that of the above embodiment.

According to the second modification, the cover 24 is attached to each of the metal laths MR; thus, when the resin seal portion 23 is formed, inflow of a molten resin, which is injected through a runner, toward central portions of the collectors 22 can be completely prevented. Also, caulking crushes through-holes in a peripheral end portion of each of the collectors 22, thereby preventing lateral flow of fuel gas and oxidizer gas. Therefore, even in the second modification, similar effect as in the case of the above embodiment can be yielded.

The present invention is not limited to the above embodiment and modifications and can be embodied in various other forms. For example, according to the above embodiment and modifications, substantially hexagonal through-holes are formed in the metal lath MR. However, no limitation is imposed on the shape of through-holes formed in the metal lath MR, so long as the shape allows appropriate flow and diffusion of externally introduced gas. For example, rhombus and various other shapes can be employed.

According to the above embodiment and modifications, the fuel cell stack is formed such that the cooling water channels 30 are sandwiched between the cells T; more specifically, between the separators 10 which partially constitute the respective cells T. However, for example, the fuel cell stack can be formed as follows: the cooling water channels 30 are previously attached to two separators 10 or to a single separator 10; then, the cells T are individually formed by use of the separator(s) 10 to which the cooling water channels 30 are attached; finally, the thus-formed cells T are stacked together, thereby forming the fuel cell stack. In this case, the separator(s) 10 and the cooling water channels 30 may be metallically joined together by use of, for example, a brazing process or a diffusion bonding process.

Furthermore, according to the above embodiment and modifications, the metal lath MR in which through-holes are formed in a meshy arrangement is used to form the collector 22. However, needless to say, other porous materials (e.g., metal foam having a large number of fine through-holes) can be used to form the collector 22, so long as such materials can supply fuel gas and oxidizer gas, which are introduced from the exterior of the fuel cell stack, to the MEA 21 in an appropriately diffused manner. Even in this case, as mentioned above, formation of the stopping portion can prevent inflow of a molten resin into the porous material at the time of integrally forming the resin seal portion.

1. A polymer electrolyte fuel cell comprising a plurality of separators for preventing mixing of externally introduced fuel gas and oxidizer gas, and electrode structures disposed between the separators, each of the electrode structures having a membrane-electrode assembly and collectors, the membrane-electrode assembly being configured such that an anode electrode layer and a cathode electrode layer are formed integrally with a predetermined electrolyte membrane, the collectors being superposed respectively on the anode electrode layer and the cathode electrode layer and adapted to supply the fuel gas introduced via the corresponding separator to the anode electrode layer in a diffused manner and the oxidizer gas introduced via the corresponding separator to the cathode electrode layer in a diffused manner and to collect electricity generated through electrode reactions in the membrane-electrode assembly,
wherein each of the collectors is formed from a plate-like porous material having a large number of through-holes and has a hole-diameter-reduced portion which is formed at a peripheral end portion of the collector and in which the through-holes are reduced in diameter, and
each of the electrode structures has a resin seal member adapted to seal the introduced fuel gas and oxidizer gas and formed by insert molding performed such that an injected molten resin encloses the hole-diameter-reduced portions at the peripheral end portions of the collectors.

2. A polymer electrolyte fuel cell according to claim 1, wherein the hole-diameter-reduced portion of each of the collectors is formed by subjecting to press working the peripheral end portion of the collector.

3. A polymer electrolyte fuel cell according to claim 2, wherein the hole-diameter-reduced portion of each of the collectors is formed by subjecting to press working the peripheral end portion of the collector, the peripheral end portion being in a folded condition.

4. A polymer electrolyte fuel cell according to claim 2, wherein the hole-diameter-reduced portion of each of the collectors is formed by subjecting to press working the peripheral end portion of the collector together with a strip of a plate-like porous material superposed on the peripheral end portion.

5. A polymer electrolyte fuel cell according to claim 2, wherein the hole-diameter-reduced portion of each of the collectors is formed by subjecting the peripheral end portion of the collector to press working which acts on straightly extending partial areas of the peripheral end portion.

6. A polymer electrolyte fuel cell according to claim 5, wherein the hole-diameter-reduced portion of each of the collectors is formed by subjecting the peripheral end portion of the collector to press working which acts on straightly extending staggered areas of the peripheral end portion.

7. A polymer electrolyte fuel cell according to claim 1, wherein each of the collectors has a cover to prevent inflow of the molten resin from the peripheral end portion of the collector toward a central portion of the collector during the insert molding, and
the hole-diameter-reduced portion of each of the collectors is formed as a result of caulking of the cover to the peripheral end portion of the collector.

8. A polymer electrolyte fuel cell according to claim 1, wherein the resin seal member formed by the insert molding has a thickness substantially equal to a thickness of a central portion of each of the collectors.

9. A polymer electrolyte fuel cell according to claim 1, wherein the plate-like porous material is a metal lath in which a large number of though-holes are formed in a meshy, step-like arrangement.
